(19) United States
(12) Patent Application Publication
(10) Pub. No.: US 2008/0231444 A1
(43) Pub. Date: Sep. 25, 2008

(54) Obstruction Detection Device

(76) Inventor: Matthieu Richard, Fourcatier (FR)

Correspondence Address: MICHAEL J. STRIKER, 103 EAST NECK ROAD, HUNTINGTON, NY, 11743, US

(21) Appl. No.: 12/093,362

(22) PCT Filed: Feb. 6, 2006
(86) PCT No.: PCT/EP2006/050680

§ 371 Date: May 12, 2008

(51) Int. Cl. G08B 13/18

(52) U.S. Cl. 340/552

(57) ABSTRACT

The invention provides an obstruction detection device. It comprises a light guide having at least one groove formed into one of the light-guiding surfaces of the light guide. A light emitter is provided for emitting light into the light guide, and at least one light detector is provided for detecting the intensity of light transmitted through the light guide and/or which is reflected by at least one groove inside the light guide. Further, the obstruction detection device comprises an output device for outputting an alarm signal when an absolute difference between the intensity and a reference value exceeds a threshold value.

The present invention relates to an obstruction detection device, in particular to an infrared intruder detection system.

Passive infrared detection systems are widely used in intruder detection systems. Their underlying principle is to detect far infrared radiation (wavelength greater than 10 μm). This radiation is emitted by any warm body, e.g. by a human, vehicle. A respective infrared sensor is commonly placed behind an entrance window to protect the sensor against the environment.

At daytime, most intruder detection systems are deactivated. An intruder can now manipulate the passive infrared detectors such that they remain inactive permanently. One kind of manipulation is to disguise the entrance window by a spray or liquid, which is opaque for far infrared radiation, but transparent for visual or near infrared radiation. Maintenance staff of the intruder detection system cannot see this spray and detect the manipulation of the passive infrared detector just by a glance.

According to EP 0 660 284 A1 a near infrared emitter is placed outside of an entrance window of a passive infrared detector. The emission angle of the emitter is very broad, and a part of the near infrared light will be detected by a near infrared sensor placed behind the entrance window. A spray applied to the entrance window, that is opaque for near infrared radiation will be easily detected. A spray transmittive for near infrared radiation instead can be used to sabotage a passive infrared detector.

EP 0 772 171 A1 describes a sabotage detection system, which uses a diffractive surface. Light from a light source is focussed to a detector by the diffractive surface. A spray applied to the structured diffractive surface changes the diffractive pattern and the focus point. This leads to a change in the intensity of light detected by the detector. Unfortunately, it is difficult to manufacture the complex diffractive surface in cheap and widely used synthetic materials.

U.S. Pat. No. 5,499,016 and EP 0 817 148 A1 propose to use an infrared emitter and a detector both arranged at the outer side of the entrance window. The infrared radiation of the emitter is scattered on the surface and in volume of the entrance window. The volume scattering is dominant. The reflected parts are detected by the near infrared detector. A spray applied to the surface of the entrance window partly changes the reflective properties of the entrance windows and thus the intensity detected by the near infrared detector. A spray applied to the entrance window will basically form a smooth film. The differences of the surface properties of the entrance window and the liquid contribute to a change of the intensity of light scattered to the detector. This change, however, is very small. The dominate part of the light scattered by the volume is not affected by the liquid and remains unchanged. Thus highly sensitive detectors are necessary in order to measure the small change. The mechanical set-up of EP 0 817 148 A1 uses light guides for emitting and detecting light to and from the entrance window, respectively. A grazing incidence of the light is achieved, which increases the sensitivity on a spray applied to the entrance window, but on the expense of a complex mechanical light guide structure.

### DISCLOSURE OF THE INVENTION

The present invention provides an obstruction detection device defined by the features of claim 1, which is highly sensitive and easy to manufacture.

The obstruction detection device comprises a light guide having at least one groove formed into one of the light-guiding surfaces of the light guide. A light emitter is provided for emitting light into the light guide, and at least one light detector is provided for detecting the intensity of light transmitted through the light guide and/or which is reflected by at least one groove inside the light guide. Further, the obstruction detection device comprises an output device for outputting an alarm signal when an absolute difference between the intensity and a reference value exceeds a threshold value. This corresponds to the use of a lower and an upper threshold.

A light guide has at least two entrance facets for injecting and ejecting light. The other surfaces are forming light-guiding surfaces. Their well-known principle is to deflect light being incident under a small angle with respect to the light-guiding surfaces. These light guides may have a rod-like structure or are thin films. According to an idea of the present invention, a groove is formed into the light-guiding surfaces. A ray of light in the light guide will hit the facets of this groove at an angle that is larger compared to an incident angle with the light-guiding surfaces. A fraction of this ray of light will therefore be scattered out of the light guide. This reduces the amount of light arriving at the light detector. A spray applied to the grooves fills them and a smooth film covers the light-guiding surfaces. Most liquids tend to have a refractive index of about 1.33. The refractive index of the materials of light guides is about 1.4 to 1.5. Thus, the respective refractive indexes do not differ very much. The filled grooves could be regarded as “repaired” and now forming a smooth light-guiding surface. In consequence, the quality of the light guide increases and a higher fraction of light injected into the light guide is transmitted to the light detector.

Advantageous refinements are given in the examples and dependent claims.

According to a refinement, the light guide is formed by the entrance window of the infrared intruder detection system. The entrance window is usually formed by a small film of glass or synthetic material and thus ensures the properties of a light guide. The entrance window can be flat or curbed in any direction.

The grooves may be elongated and arranged under an angle of 20 to 70 degrees with respect to an axis of the light guide being parallel to a principal transmission direction of the light guide. The grooves tilted with respect to the travelling light cause a fraction of light to be transmitted without deflection, a fraction of light to be reflected at the grooves and a further fraction of light to be ejected by the grooves out of the light guide. An output device can comprise a comparator for comparing the intensity of the transmitted light to the intensity of light reflected at the grooves. When a spray is applied, the intensity of light reflected at the grooves will diminish and the intensity of the transmitted light will increase. This characteristic is easier to detect than only an increase or decrease of an intensity.

The light emitter may be arranged to emit perpendicular to a first region of the light-guiding surface, wherein said first region is diffusive. A second region of the light-guiding surface may be as well diffusive, and the light detector is arranged with its detection cone perpendicular to this second region. This allows to inject the light into the light guide and detect light transmitted by the light guide or reflected by the grooves.

Instead or additionally, a prism may be arranged between the light emitter and the light guide and/or a prism may be arranged between the light guide and the light detector. The prism is used to reduce the emission cone and detection cone to the size of the entrance facets of the light guide.

The present invention will be described by examples and figures hereinafter.

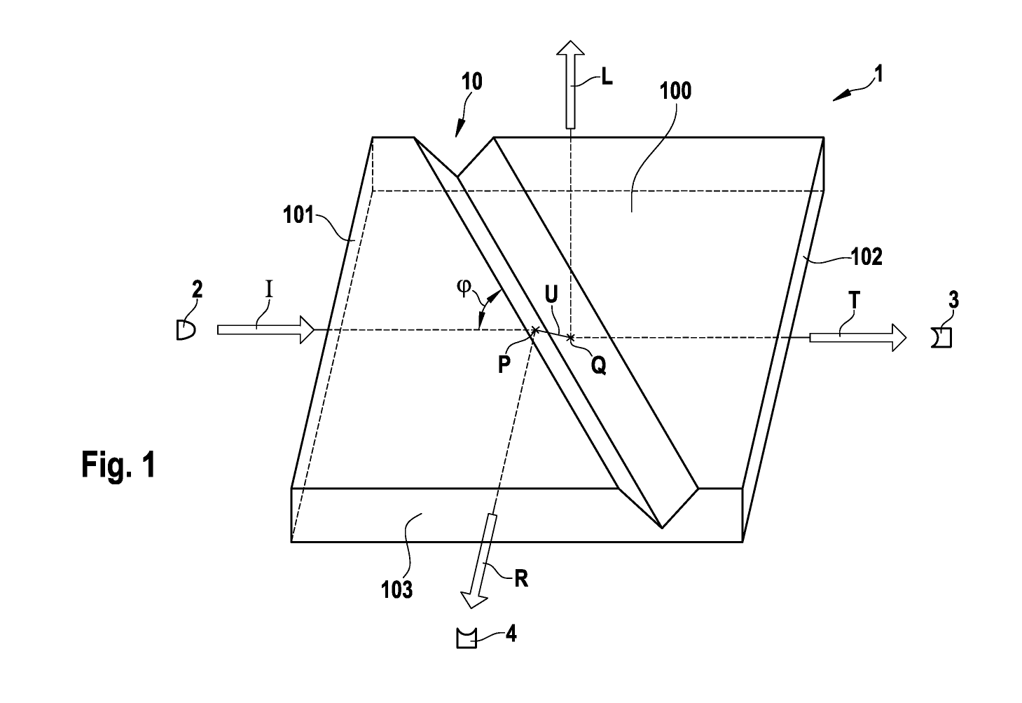

FIG. 1: a three-dimensional representation of one embodiment;

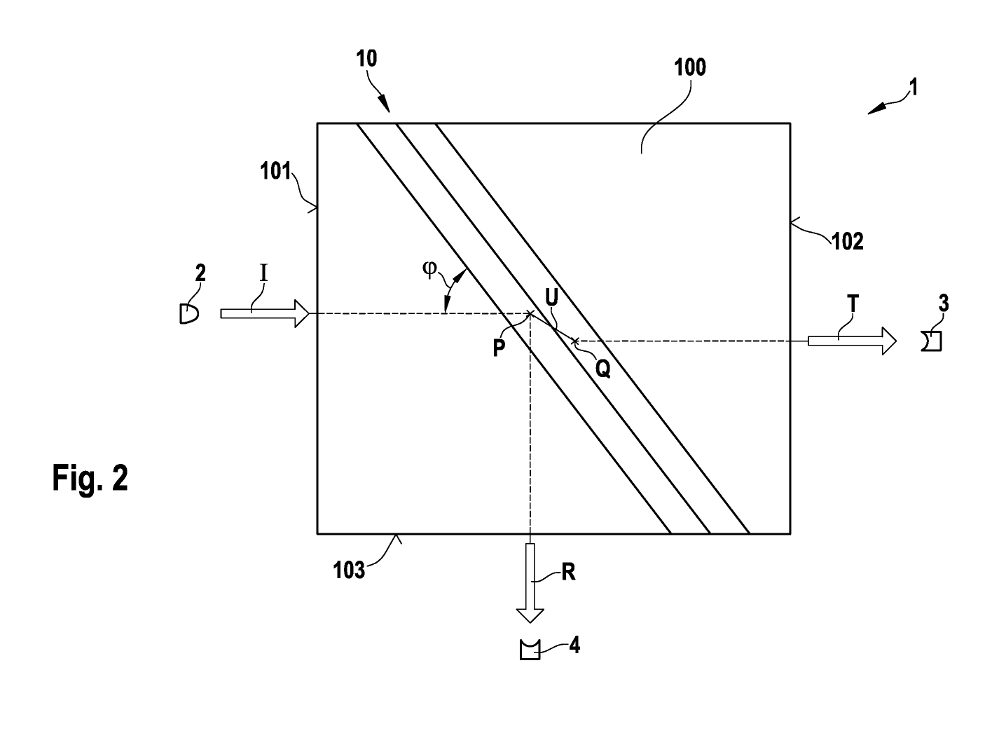

FIG. 2: top view on the embodiment of FIG. 1;

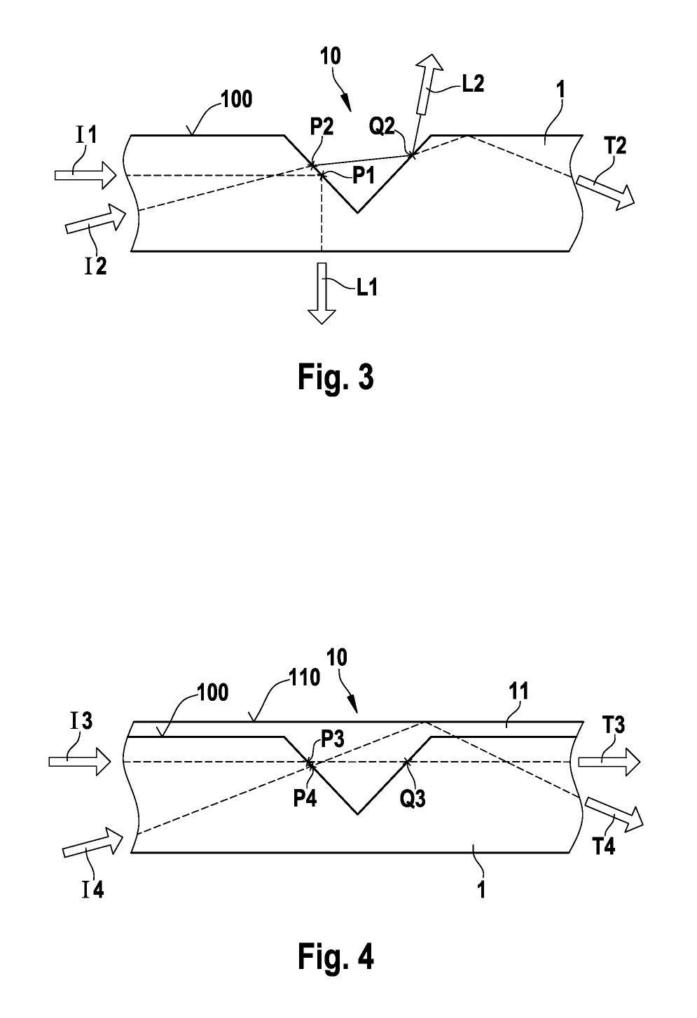

FIG. 3: representation of guiding properties of the embodiment without spray;

FIG. 4: representation of guiding properties of the embodiment with spray applied;

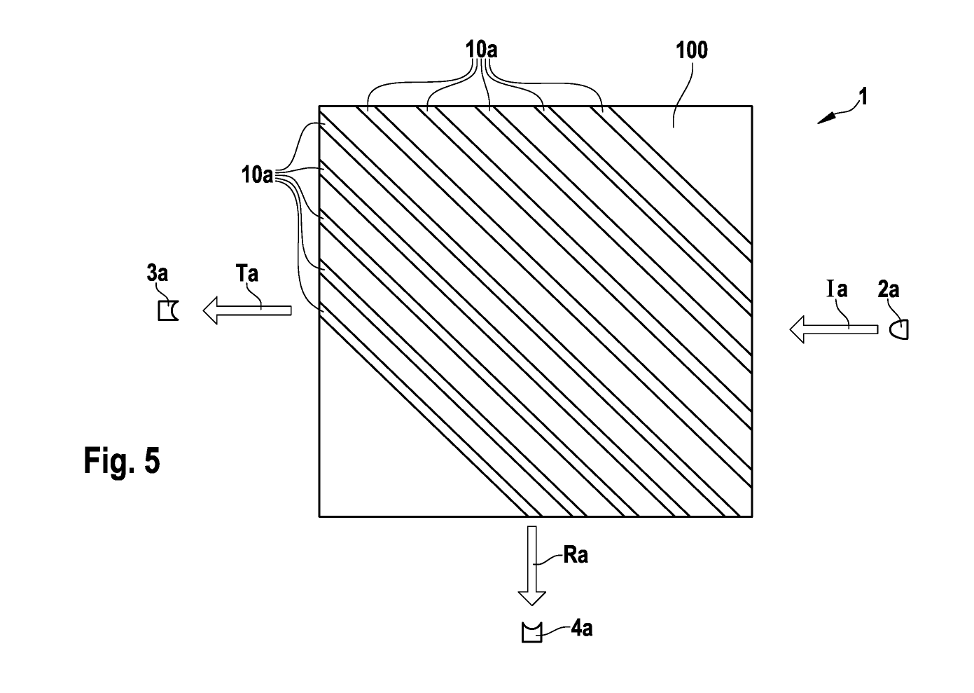

FIG. 5: top view of a further embodiment;

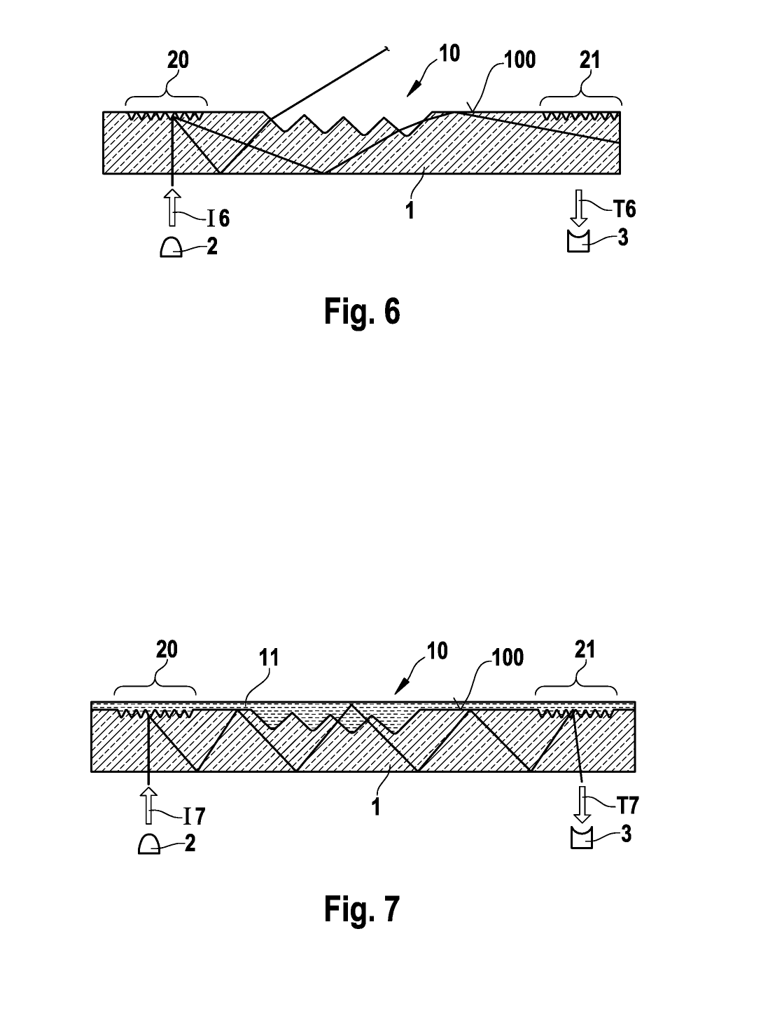

FIG. 6: cross-section of one embodiment without spray applied;

FIG. 7: cross-section of the embodiment of FIG. 6 with spray applied; and

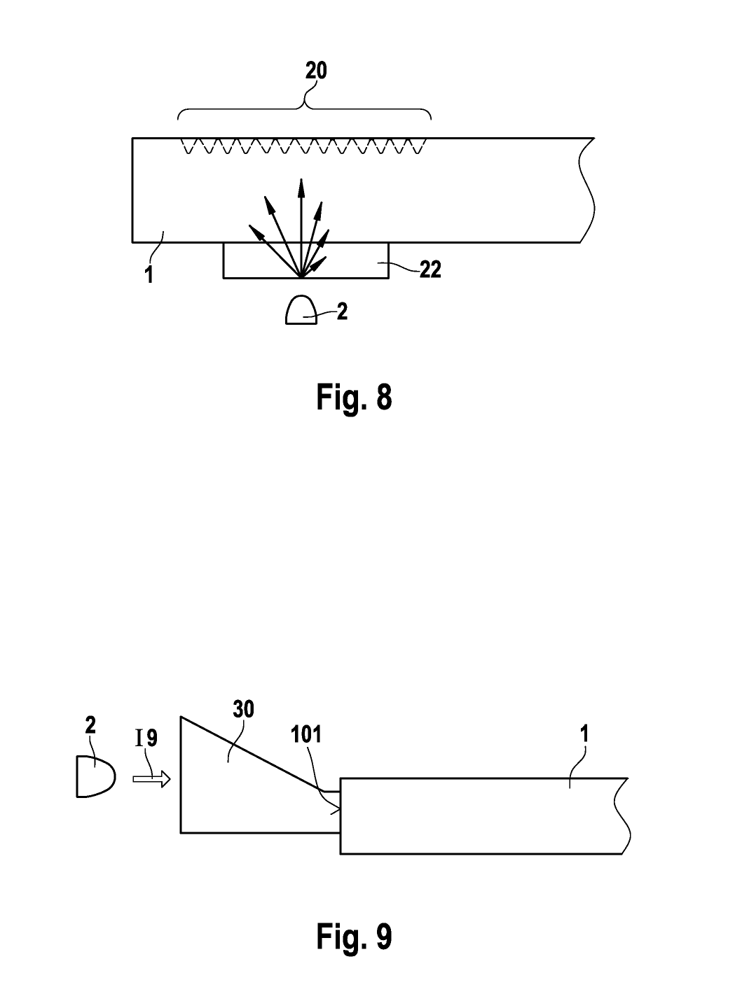

FIG. 8: top view of the embodiment of FIG. 6.

In the drawings, like numerals refer to the same or similar functionality throughout the several figures.

FIG. 1 shows a three-dimensional representation of a flat light guide 1. This light guide may can be arranged on top of an entrance window. The window and the light guide may be curbed, elongated or rod-shaped as well.

An infrared light emitting diode 2 or any other light emitter injects a ray of light I into a side facet 101 of the entrance window 1. This light ray I is guided by the entrance window 1 between its top surface 100 and its bottom surface. These two surfaces are forming the light-guiding surfaces.

A prism or triangular-shaped groove 10 is formed into the top surface 100 of the entrance window 1. The orientation of the groove 10 within the plane of the top surface 10 is tilted by an angle φ with respect to the incident ray I.

An incident ray I hits a sidewall of the groove 10 at a point P. One fraction of the incident ray I will be reflected into a reflected ray R. Another part will be refracted at the sidewall of the groove 10, thus leaving the entrance window 1 and entering the volume of the groove 10. Now, depending on the orientation of the refracted ray U and the geometry of the groove, this refracted ray U hits another side-wall of the groove 10 at a point Q. At the point Q, the ray U may be again reflected into a ray L, which is directed away from the entrance window 1. At point Q, a part is refracted back inside to the entrance window 1. This double-refracted ray will be emitted as a transmitted ray T by a side facet 102 of the entrance window 1. FIG. 2 illustrates a top view of the above-described FIG. 1 and the entrance window 1.

The groove 10 splits the incident ray I into three parts: a transmitted ray T, a reflected ray R and lost rays L. The relative intensity of the transmitted ray and the reflected ray depends on the geometry of the groove 10, in particular on the orientations of the sidewalls with respect to the incident ray I and on the relation of the refractive index of the entrance window 1 and the refractive index of the medium filling the groove 10.

The dependence on the medium filling the grooves 10 is explained along with FIGS. 3 and 4. In FIG. 3, an entrance window 1 is shown. Its refractive index is about 1.4 to 1.5. This is the common range of refractive indexes for glasses or transparent synthetic materials. The groove 10 is filled with air which has a refractive index of about 1.0. A first incident ray I1 has an orientation parallel to the guiding surface 100. At a point P1, the incident ray I1 is reflected by a sidewall of the groove 10. This is partly due to the large difference between the two refractive indexes of the entrance window 1 and the air. After the reflection, the ray L1 is directed away from the guiding surfaces 100 and is lost for the light guide 1. A second incident ray I2 is tilted by an angle with respect to the guiding surfaces 100. The ray hits the sidewall under a small angle with respect to the normal of the sidewall at a point P2. A dominant part of the ray I2 will be refracted and depending on the geometry hitting the opposing sidewall at a point Q2. This sidewall will reflect a part of the ray E2 into a lost ray L2 and refract another part back into the entrance window 1. The latter part can be detected as transmitted ray T2. In conclusion, the intensity of the transmitted rays is smaller than of the injected rays I1, I2.

In FIG. 3, the entrance window 1 is covered by a liquid or spray 11. It is assumed that the liquid completely fills the groove 10 and forms a planar surface 110 which is parallel to the top surface 100 of the entrance window 1. Most liquids, like water, have a refractive index of about 1.3. Thus its difference to the refractive index of the entrance window is by far smaller than the difference between the refractive indexes of air (1.0) and the entrance window (1.4-1.5). A ray I3 injected into the entrance window 1 similar to ray I1, having an orientation parallel to the top surface 100 will not be subdued to a total reflection at a sidewall of the groove 10. The ray I3 is refracted at the point P3, but its orientation only changes very slightly because of the small difference between the two refractive indexes of the entrance window and the liquid. Thus, the incident ray I3 is basically completely transmitted into a transmitted ray T3. An incident ray I4 is tilted with respect to the top surface 100 similar to the ray I1. The ray I4 leaves the entrance window at a point P4. Thus it will be reflected at a top surface 110 and redirected into the entrance window 1. The difference of the refractive index of air and the liquid is insufficient for a total reflection for such rays I4, which are incident under a large angle with respect to the normal of the top surface 110. Thus as well, most of the rays I4 are transmitted as transmitted rays T4.

A comparison of FIG. 3 and FIG. 4 shows that the intensity of transmitted light increases significantly, when a liquid is applied onto the top surface of the entrance window 1 and its grooves 10.

In FIGS. 1 and 2, it is shown that a part of the incident ray is reflected by the sidewalls of the grooves 10. According to an optical principle the reflectivity of an interface between two mediums is approximately proportional to the quotient of the refractive indexes of the mediums. The refractive index of the spray differs less with respect to the refractive index of the entrance window compared to the refractive index of air. Thus the intensity of the reflected light decreases when a liquid is applied to the top surface 100 of the entrance window.

Several electronic circuits or data processing methods can be applied to determine if a liquid is present on the entrance window, and an alarm signal should be put out.

A detector 3 can be arranged to detect the transmitted light T. If the intensity decreases below a predetermined threshold value, the alarm signal is put out. For this method, the intensity of the injected light I needs to be stabilized or the threshold value to be corrected corresponding to the intensity of the injected light I. Instead of detecting the intensity of the transmitted light T, the intensity of a reflected light R can be detected. In this case, an decrease of the intensity above a threshold value triggers the output of an alarm signal. A more sophisticated method measures both the transmission and the reflection. A quotient of the intensity of the transmitted to the reflected light is determined. An alarm signal is put out if this quotient decreases below and/or increases above respective threshold values. This method is independent on the intensity of the injected light I.

FIG. 5 shows an entrance window 1 having a plurality of grooves 10a formed into its top surface 100. Each groove contributes to the deflection of light and thus enhances the signal indicating whether a liquid is applied to the top surface 100 of the entrance window 1. This contributes to the sensitivity of this embodiment.

FIGS. 6 and 7 illustrate an entrance window 1 having diffusive regions 20. These diffusive regions 20 may be provided by scratching or sand-polishing the top surface 100. The injected ray I6 is directed perpendicular to the top surface 100 of the entrance window. The diffusive region 20, however, redistributes this ray in almost all directions. A part of the incident ray I6 is guided by the entrance window 1. As the light is passing the grooves 10, its intensity diminishes (or remains almost constant as depicted in FIG. 7). A second diffusive area 21 is arranged opposite to a detector 3. A part of the transmitted and guided light will be redirected into a transmitted ray T7 and registered by the detector 3.

A diffuser 22 can be arranged between a light emitter 2 and a bottom surface of the entrance window 1 in order to enhance the amount of light guided within the entrance window 1. The diffuser must be contacted properly to the light emitter without any air gaps in between. This diffuser can be used additionally or instead of the diffusive areas 20, 21.

A prism 30 can be placed between a side facet 101 and the light emitter 2. The broader side of the prism 30 collects most of the emitted light I9. The side facets of the prisms 30 are guiding the light and collimating it to a diameter of the entrance window 1.

The above described embodiments can be implemented as the entrance window of the infrared detector. In an other embodiment the light guide is formed as a separate film and placed on top of the entrance window. Thus the optical properties of the light guide and the entrance window may be chosen separately. The light guide must be transparent in the visual and the near infrared range. But it can be requested that the entrance window has to be opaque in this range. This is easily achieved by a sandwich structure of two different materials. It is understood that both materials must be transparent in the far infrared range. The light guide may be formed of polyethylene or polypropylene.

The above-described embodiments are not limiting the scope of the present invention. Someone skilled in the art easily applies changes to the described subject matter without being inventive.

The grooves 10 may be orientated perpendicular to the incident ray I.

Instead of elongated grooves, short grooves or conically shaped grooves can be used. The cross-section of the grooves can be of any shape. Other forms are elliptical and circular.

The fraction of light lost by the diffusive areas can be used to detect a cover attack. A sheet of paper or any other hard cover reflects of least a part of this lost light. The reflected light is detected by the light detector or a further light detector. An increase above a predetermined threshold triggers an alarm.

The present invention relates to an obstruction detection device, in particular to an infrared intruder detection system.

Passive infrared detection systems are widely used in intruder detection systems. Their underlying principle is to detect far infrared radiation (wavelength greater than 10 μm). This radiation is emitted by any warm body, e.g. by a human, vehicle. A respective infrared sensor is commonly placed behind an entrance window to protect the sensor against the environment.

At daytime, most intruder detection systems are deactivated. An intruder can now manipulate the passive infrared detectors such that they remain inactive permanently. One kind of manipulation is to disguise the entrance window by a spray or liquid, which is opaque for far infrared radiation, but transparent for visual or near infrared radiation. Maintenance staff of the intruder detection system cannot see this spray and detect the manipulation of the passive infrared detector just by a glance.

According to EP 0 660 284 A1 a near infrared emitter is placed outside of an entrance window of a passive infrared detector. The emission angle of the emitter is very broad, and a part of the near infrared light will be detected by a near infrared sensor placed behind the entrance window. A spray applied to the entrance window, that is opaque for near infrared radiation will be easily detected. A spray transmittive for near infrared radiation instead can be used to sabotage a passive infrared detector.

EP 0 772 171 A1 describes a sabotage detection system, which uses a diffractive surface. Light from a light source is focussed to a detector by the diffractive surface. A spray applied to the structured diffractive surface changes the diffractive pattern and the focus point. This leads to a change in the intensity of light detected by the detector. Unfortunately, it is difficult to manufacture the complex diffractive surface in cheap and widely used synthetic materials.

U.S. Pat. No. 5,499,016 and EP 0 817 148 A1 propose to use an infrared emitter and a detector both arranged at the outer side of the entrance window. The infrared radiation of the emitter is scattered on the surface and in volume of the entrance window. The volume scattering is dominant. The reflected parts are detected by the near infrared detector. A spray applied to the surface of the entrance window partly changes the reflective properties of the entrance windows and thus the intensity detected by the near infrared detector. A spray applied to the entrance window will basically form a smooth film. The differences of the surface properties of the entrance window and the liquid contribute to a change of the intensity of light scattered to the detector. This change, however, is very small. The dominate part of the light scattered by the volume is not affected by the liquid and remains unchanged. Thus highly sensitive detectors are necessary in order to measure the small change. The mechanical set-up of EP 0 817 148 A1 uses light guides for emitting and detecting light to and from the entrance window, respectively. A grazing incidence of the light is achieved, which increases the sensitivity on a spray applied to the entrance window, but on the expense of a complex mechanical light guide structure.

### DISCLOSURE OF THE INVENTION

The present invention provides an obstruction detection device defined by the features of claim 1, which is highly sensitive and easy to manufacture.

The obstruction detection device comprises a light guide having at least one groove formed into one of the light-guiding surfaces of the light guide. A light emitter is provided for emitting light into the light guide, and at least one light detector is provided for detecting the intensity of light transmitted through the light guide and/or which is reflected by at least one groove inside the light guide. Further, the obstruction detection device comprises an output device for outputting an alarm signal when an absolute difference between the intensity and a reference value exceeds a threshold value. This corresponds to the use of a lower and an upper threshold.

A light guide has at least two entrance facets for injecting and ejecting light. The other surfaces are forming light-guiding surfaces. Their well-known principle is to deflect light being incident under a small angle with respect to the light-guiding surfaces. These light guides may have a rod-like structure or are thin films. According to an idea of the present invention, a groove is formed into the light-guiding surfaces. A ray of light in the light guide will hit the facets of this groove at an angle that is larger compared to an incident angle with the light-guiding surfaces. A fraction of this ray of light will therefore be scattered out of the light guide. This reduces the amount of light arriving at the light detector. A spray applied to the grooves fills them and a smooth film covers the light-guiding surfaces. Most liquids tend to have a refractive index of about 1.33. The refractive index of the materials of light guides is about 1.4 to 1.5. Thus, the respective refractive indexes do not differ very much. The filled grooves could be regarded as “repaired” and now forming a smooth light-guiding surface. In consequence, the quality of the light guide increases and a higher fraction of light injected into the light guide is transmitted to the light detector.

Advantageous refinements are given in the examples and dependent claims.

According to a refinement, the light guide is formed by the entrance window of the infrared intruder detection system. The entrance window is usually formed by a small film of glass or synthetic material and thus ensures the properties of a light guide. The entrance window can be flat or curbed in any direction.

The grooves may be elongated and arranged under an angle of 20 to 70 degrees with respect to an axis of the light guide being parallel to a principal transmission direction of the light guide. The grooves tilted with respect to the travelling light cause a fraction of light to be transmitted without deflection, a fraction of light to be reflected at the grooves and a further fraction of light to be ejected by the grooves out of the light guide. An output device can comprise a comparator for comparing the intensity of the transmitted light to the intensity of light reflected at the grooves. When a spray is applied, the intensity of light reflected at the grooves will diminish and the intensity of the transmitted light will increase. This characteristic is easier to detect than only an increase or decrease of an intensity.

The light emitter may be arranged to emit perpendicular to a first region of the light-guiding surface, wherein said first region is diffusive. A second region of the light-guiding surface may be as well diffusive, and the light detector is arranged with its detection cone perpendicular to this second region. This allows to inject the light into the light guide and detect light transmitted by the light guide or reflected by the grooves.

Instead or additionally, a prism may be arranged between the light emitter and the light guide and/or a prism may be arranged between the light guide and the light detector. The prism is used to reduce the emission cone and detection cone to the size of the entrance facets of the light guide.

The present invention will be described by examples and figures hereinafter.

FIG. 1: a three-dimensional representation of one embodiment;

FIG. 2: top view on the embodiment of FIG. 1;

FIG. 3: representation of guiding properties of the embodiment without spray;

FIG. 4: representation of guiding properties of the embodiment with spray applied;

FIG. 5: top view of a further embodiment;

FIG. 6: cross-section of one embodiment without spray applied;

FIG. 7: cross-section of the embodiment of FIG. 6 with spray applied; and

FIG. 8: top view of the embodiment of FIG. 6.

In the drawings, like numerals refer to the same or similar functionality throughout the several figures.

FIG. 1 shows a three-dimensional representation of a flat light guide 1. This light guide may can be arranged on top of an entrance window. The window and the light guide may be curbed, elongated or rod-shaped as well.

An infrared light emitting diode 2 or any other light emitter injects a ray of light I into a side facet 101 of the entrance window 1. This light ray I is guided by the entrance window 1 between its top surface 100 and its bottom surface. These two surfaces are forming the light-guiding surfaces.

A prism or triangular-shaped groove 10 is formed into the top surface 100 of the entrance window 1. The orientation of the groove 10 within the plane of the top surface 10 is tilted by an angle φ with respect to the incident ray I.

An incident ray I hits a sidewall of the groove 10 at a point P. One fraction of the incident ray I will be reflected into a reflected ray R. Another part will be refracted at the sidewall of the groove 10, thus leaving the entrance window 1 and entering the volume of the groove 10. Now, depending on the orientation of the refracted ray U and the geometry of the groove, this refracted ray U hits another sidewall of the groove 10 at a point Q. At the point Q, the ray U may be again reflected into a ray L, which is directed away from the entrance window 1. At point Q, a part is refracted back inside to the entrance window 1. This double-refracted ray will be emitted as a transmitted ray T by a side facet 102 of the entrance window 1. FIG. 2 illustrates a top view of the above-described FIG. 1 and the entrance window 1.

The groove 10 splits the incident ray I into three parts: a transmitted ray T, a reflected ray R and lost rays L. The relative intensity of the transmitted ray and the reflected ray depends on the geometry of the groove 10, in particular on the orientations of the sidewalls with respect to the incident ray I and on the relation of the refractive index of the entrance window 1 and the refractive index of the medium filling the groove 10.

The dependence on the medium filling the grooves 10 is explained along with FIGS. 3 and 4. In FIG. 3, an entrance window 1 is shown. Its refractive index is about 1.4 to 1.5. This is the common range of refractive indexes for glasses or transparent synthetic materials. The groove 10 is filled with air which has a refractive index of about 1.0. A first incident ray I1 has an orientation parallel to the guiding surface 100. At a point P1, the incident ray I1 is reflected by a sidewall of the groove 10. This is partly due to the large difference between the two refractive indexes of the entrance window 1 and the air. After the reflection, the ray L1 is directed away from the guiding surfaces 100 and is lost for the light guide 1. A second incident ray I2 is tilted by an angle with respect to the guiding surfaces 100. The ray hits the sidewall under a small angle with respect to the normal of the sidewall at a point P2. A dominant part of the ray I2 will be refracted and depending on the geometry hitting the opposing sidewall at a point Q2. This sidewall will reflect a part of the ray E2 into a lost ray L2 and refract another part back into the entrance window 1. The latter part can be detected as transmitted ray T2. In conclusion, the intensity of the transmitted rays is smaller than of the injected rays I1, I2.

In FIG. 3, the entrance window 1 is covered by a liquid or spray 11. It is assumed that the liquid completely fills the groove 10 and forms a planar surface 110 which is parallel to the top surface 100 of the entrance window 1. Most liquids, like water, have a refractive index of about 1.3. Thus its difference to the refractive index of the entrance window is by far smaller than the difference between the refractive indexes of air (1.0) and the entrance window (1.4-1.5). A ray I3 injected into the entrance window 1 similar to ray I1, having an orientation parallel to the top surface 100 will not be subdued to a total reflection at a sidewall of the groove 10. The ray I3 is refracted at the point P3, but its orientation only changes very slightly because of the small difference between the two refractive indexes of the entrance window and the liquid. Thus, the incident ray I3 is basically completely transmitted into a transmitted ray T3. An incident ray I4 is tilted with respect to the top surface 100 similar to the ray I1. The ray I4 leaves the entrance window at a point P4. Thus it will be reflected at a top surface 110 and redirected into the entrance window 1. The difference of the refractive index of air and the liquid is insufficient for a total reflection for such rays I4, which are incident under a large angle with respect to the normal of the top surface 110. Thus as well, most of the rays I4 are transmitted as transmitted rays T4.

A comparison of FIG. 3 and FIG. 4 shows that the intensity of transmitted light increases significantly, when a liquid is applied onto the top surface of the entrance window 1 and its grooves 10.

In FIGS. 1 and 2, it is shown that a part of the incident ray is reflected by the sidewalls of the grooves 10. According to an optical principle the reflectivity of an interface between two mediums is approximately proportional to the quotient of the refractive indexes of the mediums. The refractive index of the spray differs less with respect to the refractive index of the entrance window compared to the refractive index of air. Thus the intensity of the reflected light decreases when a liquid is applied to the top surface 100 of the entrance window.

Several electronic circuits or data processing methods can be applied to determine if a liquid is present on the entrance window, and an alarm signal should be put out.

A detector 3 can be arranged to detect the transmitted light T. If the intensity decreases below a predetermined threshold value, the alarm signal is put out. For this method, the intensity of the injected light I needs to be stabilized or the threshold value to be corrected corresponding to the intensity of the injected light I. Instead of detecting the intensity of the transmitted light T, the intensity of a reflected light R can be detected. In this case, an decrease of the intensity above a threshold value triggers the output of an alarm signal. A more sophisticated method measures both the transmission and the reflection. A quotient of the intensity of the transmitted to the reflected light is determined. An alarm signal is put out if this quotient decreases below and/or increases above respective threshold values. This method is independent on the intensity of the injected light I.

FIG. 5 shows an entrance window 1 having a plurality of grooves 10a formed into its top surface 100. Each groove contributes to the deflection of light and thus enhances the signal indicating whether a liquid is applied to the top surface 100 of the entrance window 1. This contributes to the sensitivity of this embodiment.

FIGS. 6 and 7 illustrate an entrance window 1 having diffusive regions 20. These diffusive regions 20 may be provided by scratching or sand-polishing the top surface 100. The injected ray I6 is directed perpendicular to the top surface 100 of the entrance window. The diffusive region 20, however, redistributes this ray in almost all directions. A part of the incident ray I6 is guided by the entrance window 1. As the light is passing the grooves 10, its intensity diminishes (or remains almost constant as depicted in FIG. 7). A second diffusive area 21 is arranged opposite to a detector 3. A part of the transmitted and guided light will be redirected into a transmitted ray T7 and registered by the detector 3.

A diffusor 22 can be arranged between a light emitter 2 and a bottom surface of the entrance window 1 in order to enhance the amount of light guided within the entrance window 1. The diffuser must be contacted properly to the light emitter without any air gaps in between. This diffuser can be used additionally or instead of the diffusive areas 20, 21.

A prism 30 can be placed between a side facet 101 and the light emitter 2. The broader side of the prism 30 collects most of the emitted light I9. The side facets of the prisms 30 are guiding the light and collimating it to a diameter of the entrance window 1.

The above described embodiments can be implemented as the entrance window of the infrared detector. In an other embodiment the light guide is formed as a separate film and placed on top of the entrance window. Thus the optical properties of the light guide and the entrance window may be chosen separately. The light guide must be transparent in the visual and the near infrared range. But it can be requested that the entrance window has to be opaque in this range. This is easily achieved by a sandwich structure of two different materials. It is understood that both materials must be transparent in the far infrared range. The light guide may be formed of polyethylene or polypropylene.

The above-described embodiments are not limiting the scope of the present invention. Someone skilled in the art easily applies changes to the described subject matter without being inventive.

The grooves 10 may be orientated perpendicular to the incident ray I.

Instead of elongated grooves, short grooves or conically shaped grooves can be used. The cross-section of the grooves can be of any shape. Other forms are elliptical and circular.

The fraction of light lost by the diffusive areas can be used to detect a cover attack. A sheet of paper or any other hard cover reflects of least a part of this lost light. The reflected light is detected by the light detector or a further light detector. An increase above a predetermined threshold triggers an alarm.

1. An obstruction detection device for an infrared intruder detection system, comprising a light guide (1) having at least one groove (10) formed into one of the light guiding surfaces (100) of the light guide (1), a light emitter (2) for emitting light into the light guide (1), at least one light detector (3,4) for detecting the intensity of light transmitted (T) through the light guide (1) and/or the intensity of reflected light (R), which is reflected by at least one groove (10) inside the light guide (1), an output device for outputting an alarm-signal, when an absolute difference between the intensity and a reference value exceeds a threshold value.

2. The obstruction detection device according to claim 1, wherein the light guide is arranged on top of an entrance window (1) of the infrared intruder detection system.

3. The obstruction detection device according to claim 2, wherein the grooves (10) are elongated and arranged under an angle of 20 to 70 degrees with respect to an axis of the light guide (1) being parallel to a principal transmission direction of the light guide (1).

4. The obstruction detection device according to claim 3, wherein the output device comprises a comparator for comparing the intensity of the transmitted light (T) to the intensity of light reflected (R) at the grooves (10).

5. The obstruction detection device according to claim 1, wherein the grooves (10) have a triangular or half-elliptical cross-section.

6. The obstruction detection device according to claim 1, wherein the light emitter (2) is arranged to emit perpendicular to a first region (20) of the light guiding surface (100), said first region (20) being diffusive.

7. The obstruction detection device according to claim 1, wherein the light detector (2) is arranged with its detection cone perpendicular to a second region (21) of the light guiding surface (100), said second region (21) being diffusive.

8. The obstruction detection device according to claim 1, wherein a prism is arranged between the light emitter (2) and the light guide (1) and/or a prism is arranged between the light guide (1) an the light detector (3).
